(19) United States
(12) Patent Application Publication
(10) Pub. No.: US 2023/0226844 A1
(43) Pub. Date: Jul. 20, 2023

(54) WRITING INSTRUMENTS AND ASSOCIATED NIB ASSEMBLIES

(71) Applicant: SANFORD L.P., Atlanta, GA (US)

(72) Inventors: William T. Ehlers, Atlanta, GA (US); John C. Depass, Atlanta, GA (US)

(21) Appl. No.: 17/995,528

(22) PCT Filed: Apr. 5, 2021
(86) PCT No.: PCT/US2021/025786

§ 371 Date: Oct. 5, 2022

Related U.S. Application Data
(60) Provisional application No. 63/005,586, filed on Apr. 6, 2020.

(51) Int. Cl. B43K 8/02; B43K 8/03; B43K 1/12

(52) U.S. Cl. CPC B43K 8/022; B43K 8/03; B43K 1/12

(57) ABSTRACT

Writing instruments may include nibs having voids for viewing a writing surface when in use. The nib includes a fibrous nib body with an upper writing portion and a lower portion configured to deliver ink from an ink reservoir to the upper writing portion. The nib has one or more elongated beams that defines a void in a two-dimensional plane through which a writing surface can be viewed when in use.

### CROSS-REFERENCE TO RELATED APPLICATIONS

This application claims priority to International Application No. PCT/US2021/025786 filed Apr. 5, 2021, which claims the benefit of U.S. Provisional Application No. 63/005,586 filed Apr. 6, 2020, both of which are hereby incorporated by reference here in their entireties.

### FIELD OF THE DISCLOSURE

This disclosure relates generally to writing instruments, and in particular, relates to writing instruments having fibrous nibs.

### BACKGROUND

Writing instruments with fibrous nibs, such as markers, pens, and highlighters, are commonly used for transferring ink to a writing surface. When a wide line is desired, a writing instrument having a fibrous nib with a sufficiently wide surface is selected so that only a single pass of the writing instrument is required to form the wide line. Unfortunately, when a right-handed user draws a line from left to right, the writing instrument and nib obstruct the view of the writing surface. A wide fibrous nib for drawing a wide line exacerbates the problem by obstructing an even greater amount of the writing surface. The problem is particularly acute when a highlighter pen is used to highlight text. To compensate, users will often draw multiple short lines instead of one long line, or draw the line while holding the writing instrument at an unnatural angle. Without compensation, the line is often misdrawn, either in the wrong place or with an irregular shape.

Prior attempts to provide writing instruments with relatively wide nibs having an improved view of the writing surface utilize a clear support structure that can be viewed through. However, in such instruments, the clear support structure itself presents an obstruction of the view of the writing surface, particularly over time as the clear support structure collects debris, defects, or discoloration.

Thus, writing instruments having fibrous nibs permitting a completely unobstructed view of the writing surface would be beneficial.

### SUMMARY

In embodiments, the present disclosure describes a nib for a writing instrument. The nib may include a self-supporting fibrous nib body including an upper writing portion and a lower portion in communication with the upper writing portion. The upper writing portion of the fibrous nib body may be configured to deliver ink to a writing surface and define a void in a two-dimensional plane bounded by at least one elongated beam. The void may allow observation of the writing surface therethrough. A first notch may be disposed on a posterior side of the fibrous nib body and a second notch may be disposed on an anterior side of the fibrous nib body. The first notch and the second notch define a boundary between the lower portion of the fibrous nib body and the upper writing portion of the fibrous nib body.

In embodiments, the present disclosure describes a writing instrument. The writing instrument may include an elongated body including an ink reservoir. The writing instrument may include the nib disposed at an end of the elongated body. The lower portion of the fibrous nib body may be disposed inside the end of the elongated body and may be configured to deliver ink from the ink reservoir to the upper writing portion of the fibrous nib body. The upper writing portion of the fibrous nib body may protrude outside of the end of the elongated body.

In embodiments, the present disclosure describes a writing instrument. The writing instrument may include an elongated body comprising an ink reservoir. The writing instrument may further include a ferrule disposed at an end of the elongated body. The writing instrument may further include a nib including a self-supporting fibrous nib body comprising an upper writing portion and a lower portion in communication with the upper writing portion. The upper writing portion of the fibrous nib body may be configured to deliver ink to a writing surface and define a void in a two-dimensional plane bounded by at least one elongated beam. The void may allow observation of the writing surface therethrough. A first notch may be disposed on a posterior side of the fibrous nib body and a second notch may be disposed on an anterior side of the fibrous nib body. The first notch and the second notch may define a boundary between the lower portion of the fibrous nib body and the upper writing portion of the fibrous nib body. The lower portion of the fibrous nib body may be disposed inside the end of the elongated body and be configured to deliver ink from the ink reservoir to the upper writing portion of the fibrous nib body. The upper writing portion of the fibrous nib body may protrude outside the end of the elongated body. The ferrule may include at least one elongated support rib for supporting the at least one elongated beam of the nib.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A is a side-view of a nib in accordance with the present disclosure.

FIG. 1B is a perspective view of a nib in accordance with the present disclosure.

FIG. 1C is a perspective view of a writing instrument writing on a writing surface in accordance with the present disclosure.

FIG. 2 is a side-view of a nib in accordance with the present disclosure.

FIG. 3 is a side-view of a nib in accordance with the present disclosure.

FIG. 4 is a schematic of a nib in accordance with the present disclosure.

FIG. 5 is a perspective view of a writing instrument in accordance with the present disclosure.

FIG. 6 is a perspective view of a writing instrument in accordance with the present disclosure.

FIG. 7A is a side view of a nib and ferrule in accordance with the present disclosure.

FIG. 7B is a perspective view of a nib and ferrule in accordance with the present disclosure.

FIG. 7C is a cross-sectional view of a nib and ferrule in accordance with the present disclosure.

FIG. 8 is a cross-sectional view of a nib and ferrule in accordance with the present disclosure.

FIG. 9 is a side-view of a writing instrument in accordance with the present disclosure.

FIG. 10 is a side-view of a writing instrument in accordance with the present disclosure.

### DETAILED DESCRIPTION

Writing instruments and associated nib assemblies are provided herein. The writing instruments and associated nib assemblies advantageously improve the visibility of a writing surface during use of the writing instrument. The present disclosure includes non-limiting embodiments of writing instruments and nibs. The embodiments are described in detail herein to enable one of ordinary skill in the art to practice the writing instruments and associated nib assemblies, although it is to be understood that other embodiments may be utilized and that logical changes may be made without departing from the scope of the disclosure. Throughout the disclosure, depending on the context, singular and plural terminology may be used interchangeably.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range. A dimension described as being “of” X “to” Y means that end points X and Y are included in the range X-Y. Similarly, “from” X “to” Y means that end points X and Y are included in the range X-Y.

Fibrous nibs are nibs formed out of fibrous materials along which ink may travel. For example, a fibrous material may be formed from a plurality of fibers and a resin, a porous elastomer, or another material. For example, highlighter pens, dry erase markers, permanent markers, felt-tip pens, and the like may use a fibrous nib that generally maintains its shape while allowing ink to travel along the fibers. Since writing instruments such as highlighter pens are often used for creating wide lines, some users experience difficulty in accurately drawing lines with such writing instruments because of the size of the fibrous nib and the opacity of the fibrous nib. In the present disclosure, the fibrous nibs include a void therein, through which a user may view a surface upon which they are writing during a writing action. As such, the present nibs may provide a means by which users can draw wide lines accurately due to the ability to view the writing surface.

Nib assemblies and writing instruments incorporating such assemblies are discussed below. The nibs are fibrous and include a void therein, through which a user may view a surface upon which they are writing during a writing action. The nibs may be produced from a plurality of fibers and resin that are subjected to a punch to define a void through which a writing surface can be viewed in use. By punching out material to form a void, it has been discovered that the nib may continue to transfer ink from an ink reservoir to a writing surface, while providing an unobstructed view of the writing surface. In certain aspects, the nibs are self-supporting such that no additional support of the upper writing portion is necessary. In other aspects, the writing instrument includes a ferrule having a support structure for the nib.

Nib Assemblies

Nibs for writing instruments are disclosed herein. In one aspect, the nib may be formed from a self-supporting fibrous nib body including an upper writing portion and a lower portion that are in communication with each other. The upper writing portion may be designed to deliver ink to a writing surface. The upper writing portion may define a void in a two-dimensional X-Y plane bounded by at least one elongated beam, i.e., the void is both an absence of material therein and an absence of material extending in a third axis such that the void is surrounded by material in only a first and second axis. The void may allow observation of a writing surface therethrough.

As used herein, the term “self-supporting” refers to a nib having sufficient structural stability that it maintains a defined shape in use, absent any supporting structures associated with the upper writing portion thereof, and that is suitable for the transfer of ink.

As used herein, a “void” refers to the absence of any solid material. The void may be filled by air. The shape of the void is defined by the fibrous nib body that defines the void. The void may be any shape, such as a square, triangle, rectangle, or other polygon depending on the application and desired nib dimensions and shape. In some embodiments, the void is formed by punching through the nib.

In some embodiments, the nib is monolithic. As used herein, “monolithic” refers to a single, homogenous structure having a continuous composition throughout. In other embodiments, the nib is formed by two or more portions that are operatively coupled in fluid communication with one another.

In some embodiments, the fibrous nib body is formed from a plurality of fibers and a resin. In other embodiments, the fibrous nib body is formed from a porous elastomer.

In some embodiments, the lower portion and the upper writing portion are defined by a first notch located on an anterior side of the fibrous nib body, and a second notch located on a posterior side of the fibrous nib body. The first notch and second notch are located in the same axis, such that a hypothetical line drawn from one notch to the other notch is perpendicular to a longitudinal axis of the nib and defines a hypothetical boundary that separates the lower portion and the upper writing portion.

In some embodiments, the notches may be positioned such that the lower portion and the upper writing portion are substantially equal in area, i.e., the notches may be positioned at the midpoint of a longitudinal axis of the nib. As used herein, “area” used in reference to comparing areas of the portions of the nib body include void areas that may be included in said portions. In other embodiments, the notches may be positioned such that the lower portion has an area greater than that of the upper writing portion. In other embodiments, the notches may be positioned such that the lower portion has an area lesser than that of the upper writing portion.

In some embodiments, the first notch and second notch extend into the fibrous nib body by about 0.1 mm to about 1.5 mm, for example about 0.2 mm, 0.5 mm, 0.7 mm, 1 mm, 1.2 mm, or about 1.4 mm. The notches could extend 0.15 mm, 0.3 mm, 0.9 mm, 1.3 mm, or any distance in between depending on the desired nib and writing instrument properties. The notches could extend into the fibrous nib body by about 1% of the fibrous nib body width, by about 5% of the fibrous nib body width, or about 10% of the fibrous nib body. The notches could extend into the fibrous nib body by about 2%, 7%, 11%, 15%, 20%, or 25% of the fibrous nib body, or any distance between depending on the desired nib and writing instrument properties.

In some embodiments, the void may be a punched area in the upper writing portion. That is, the void may be mechanically punched from a fibrous nib material to form the fibrous nib body having the void.

In some embodiments, the fibrous nib body has a thickness of about 1 mm to about 4 mm, for example about 1.5 mm, 2 mm, 3 mm, or about 3.5 mm. The fibrous nib body could have a thickness of about 1.8 mm, 2.3 mm, 2.7 mm, 3.4 mm, 3.9 mm, or any thickness in between depending on the desired nib and writing instrument properties.

In some embodiments, the fibrous nib body may include a writing beam located in the upper writing portion superior to the void. In some embodiments, the writing beam has one or more beveled edges so as to increase the surface area of the writing beam that contacts a writing surface in use.

In some embodiments, the writing beam is perpendicular to the longitudinal axis of the fibrous nib body. In other embodiments, the writing beam is positioned at an angle to the perpendicular defined by the longitudinal axis so as to change the effective angle at which the writing instrument is held by a user in use. In some embodiments, the angle is greater than 0° to about 45°, for example about 9.5°.

In some embodiments, the writing beam extends along a longitudinal axis by about 1 mm to about 2.5 mm, for example 1.4 mm, 1.8 mm, 2.2 mm, or about 2.4 mm. The writing beam could extend by 1.2 mm, 1.5 mm, 1.7 mm, 2.1 mm, or any distance in between depending on the desired nib and writing instrument properties.

In some embodiments, the fibrous nib body has a length of about 15 mm to about 30 mm, for example 18 mm, 20 mm, 25 mm, or about 28 mm. The fibrous nib body could have a length of about 16 mm, 21 mm, 27 mm, 29 mm, or any length in between depending on the desired nib and writing instrument properties. In some embodiments, the fibrous nib body has a width of about 5 mm to about 10 mm, for example 6 mm, 7 mm, 8 mm, 9 mm, or any width in between depending on the desired nib and writing instrument properties. In some embodiments, the fibrous nib body has a length-to-width ratio of about 1:1, about 1.5:1, about 2:1, about 2.5:1, about 3:1, about 3.5:1, about 4:1, or any ratio in between depending on the desired nib and writing instrument properties.

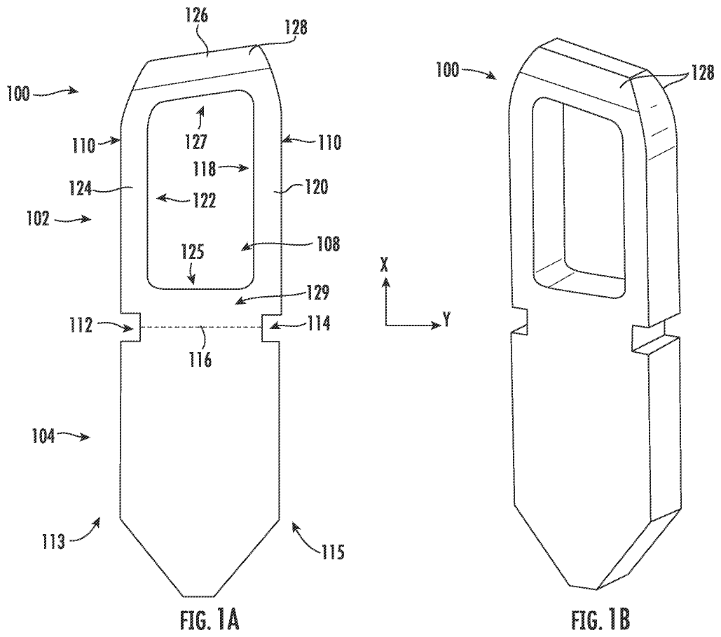

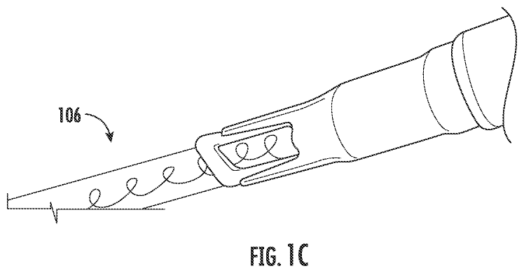

FIG. 1A is a side-view of a nib 100 including a fibrous nib body having an upper writing portion 102 and a lower portion 104 that are in communication with each other, with the upper writing portion 102 designed to deliver ink to a writing surface 106. A void 108 is defined in a two-dimensional X-Y plane within the upper writing portion 102 bounded by at least one elongated beam 110. A first notch 112 is located on a posterior side 113 of the fibrous nib body and a second notch 114 is located on an anterior side 115 of the fibrous nib body. The first notch 112 and the second notch 114 define a hypothetical boundary 116 separating the upper writing portion 102 and the lower portion 104. The void 108 is bordered on an anterior side 118 by an anterior elongated beam 120, and bordered on a posterior side 122 by a posterior elongated beam 124. The void 108 is bordered on an inferior side 125 by an inferior piece of the upper writing portion 129. A writing beam 126 borders the void 108 on a superior side 127. The writing beam 126 has one or more beveled surfaces 128.

FIG. 1B is a perspective view of the nib 100 of FIG. 1A. FIG. 1C is a perspective view of a writing instrument having a nib 100 writing on a writing surface 106. In some instances, the void is defined by four sides. In other instances, the void may have three sides, 5 sides, 6 sides, or more, depending on the shape of the nib. The void may have a polygonal shape substantially the same as the upper writing portion, i.e., each side of the void is equidistant from the elongated beams and writing beam of the upper writing portion. The void may have a shape that is different from the upper writing portion, i.e., one or more beams may have a width that varies. The void may have rounded corners, or the void may have sharp corners.

The lower portion of the nib body may taper to a substantially triangular point, or the lower portion of the nib body may have a substantially rectangular shape. In some embodiments, the lower portion of the nib body may begin to taper such that the inferior-most 10% of the lower portion, the inferior-most 20% of the lower portion, the inferior-most 30%, 40%, 50%, or any proportion of the lower portion of the nib body in between is part of the tapered end. In some embodiments, the lower portion of the nib body has a width substantially equal to the width of the nib body. In other embodiments, the lower portion has a width lesser than the width of the nib body. In some embodiments, the lower portion transfers a liquid, such as ink, from a source of liquid located inferior to the lower portion of the nib body to the upper writing portion of the nib body.

The anterior and posterior elongated beams may begin to curve towards each other at the point where they meet the writing beam, or they may maintain a straight, unchanging profile when they meet the writing beam. The notches may be rectilinear, the notches may have curved edges, or the notches may have rounded corners. One side of the writing beam may be beveled while the opposite side is not, or both or neither sides may be beveled. The elongated beams may be rectilinear such that a cross-section of the beam is a rectangle, or the elongated beams may have chamfered corners such that a cross-section of the beam is a rounded rectangle.

In some instances, the void may be formed by punching through the nib using a punch having the desired void size and shape. In other instances, the void may be formed by a mold in which the nib is formed, i.e., a nib formed from fibrous material and resin may be formed in a mold designed to produce a nib having a void. Any suitable means for forming the void may be used.

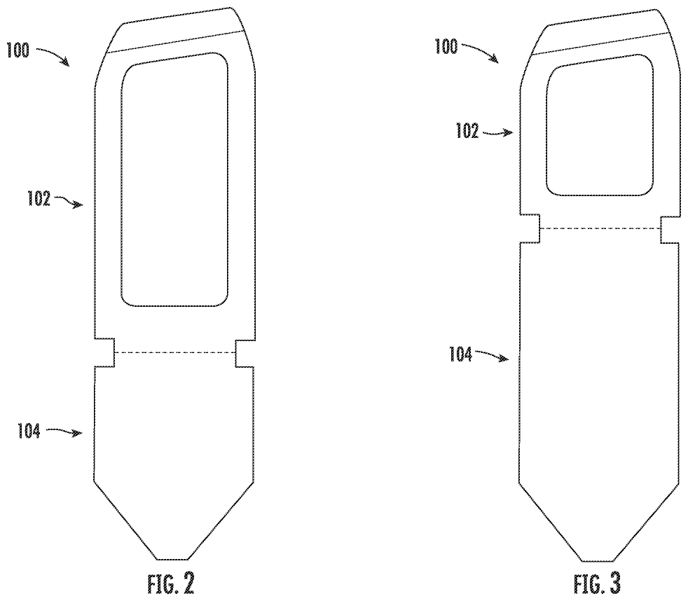

FIG. 2 is a side-view of a nib 100 including a fibrous nib body having an upper writing portion 102 and lower portion 104. First notch 112 and second notch 114 are located such that the upper writing portion 102 has a greater area than lower portion 104.

FIG. 3 is a side-view of a nib 100 including a fibrous nib body having an upper writing portion 102 and lower portion 104. First notch 112 and second notch 114 are located such that the lower portion 104 has a greater area than upper writing portion 102.

Writing Instruments

Writing instruments are also disclosed herein. In one aspect, the writing instrument may include an elongated body having an ink reservoir and a fibrous nib body, such as the self-supporting fibrous nib body described above. The fibrous nib body may have a lower portion disposed in the end of the elongated body and in fluid communication with the ink contained in the ink reservoir, and an upper writing portion that protrudes from the end of the elongated body such that the fibrous nib body transfers ink from the ink reservoir to a writing surface. The upper writing portion may define a void in a two-dimensional X-Y plane by at least one elongated beam. In another aspect, the writing instrument may include a ferrule at the end of the elongated body for supporting the fibrous nib body. In such embodiments, the fibrous nib body may include any suitable configuration (e.g., materials and structure), including any combination of features described herein, and may be self-supporting or not. Thus, the ferrule may provide the structural support for a non-self-supporting nib body, or may supplement the support provided by a self-supporting nib body.

In some embodiments, the ferrule has at least one elongated support rib for supporting the at least one elongated beam of the nib body. In some embodiments, the ferrule has an anterior elongated support rib for supporting an anterior elongated beam of the nib and a posterior elongated support rib for supporting a posterior elongated beam of the nib.

In some embodiments, the anterior elongated support rib and posterior elongated support rib each include a first groove that corresponds to the anterior elongated beam and the posterior elongated beam so as to support the fibrous nib body and prevent the fibrous nib body from deforming in use. In some embodiments, the anterior elongated support rib and posterior elongated support rib each include a second groove within the first groove that corresponds to a first protrusion on the anterior elongated beam and a second protrusion on the posterior support beam. The second grooves and protrusions further support the fibrous nib body and prevent the nib from deforming or detaching from the ferrule in use.

In some embodiments, the anterior elongated support rib and the posterior elongated support rib are equal in length. In other embodiments, the anterior elongated support rib has a length greater than a length of the posterior elongated support rib.

In some embodiments, the writing instrument is a highlighter. In other embodiments, the writing instrument is a permanent marker. In other embodiments, the writing instrument is a dry-erase marker. In other embodiments, the writing instrument is a pen.

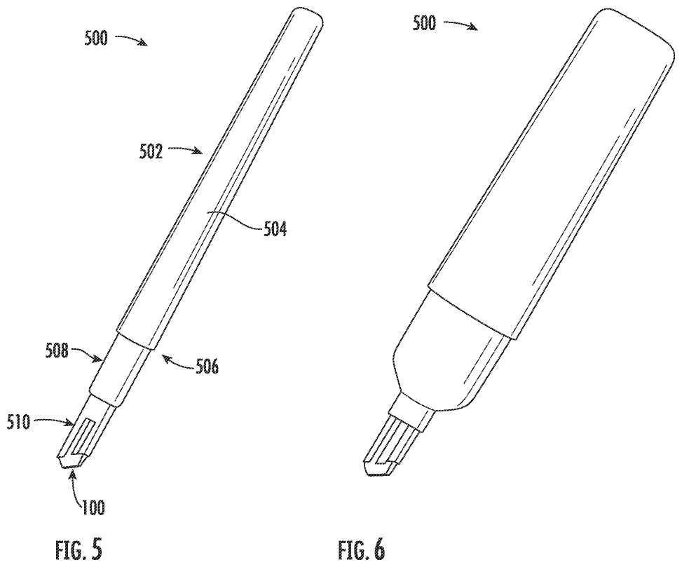

FIG. 5 and FIG. 6 are perspective views of a writing instrument 500 including an elongated body 502 having an ink reservoir 504 therein. A ferrule 508 is disposed at an end 506 of the elongated body 502 and is configured to support a nib 100 with one or more elongated support ribs 510.

In some instances, the writing instrument may have a round shape. In other instances, the writing instrument may have another shape, such as rectangular, triangular, or some other polygon. Any suitable shape for a writing instrument may be used. In some instances, the writing instrument has a cross-sectional area that substantially corresponds to the size of the line width drawn by the nib, as depicted in FIG. 5. In other instances, the elongated body has a substantially increased cross-sectional area corresponding to a larger ink reservoir, as depicted in FIG. 6. When the ink reservoir volume is substantially increased, the shape of the ferrule may change where it meets the end of the elongated body to match the cross-sectional area of the elongated body, though the dimensions of the elongated support ribs of the ferrule remain governed by the dimensions of the nib. In this way, the dimensions and other design considerations that affect the nib are separated from the dimensions and other design considerations that affect the elongated body.

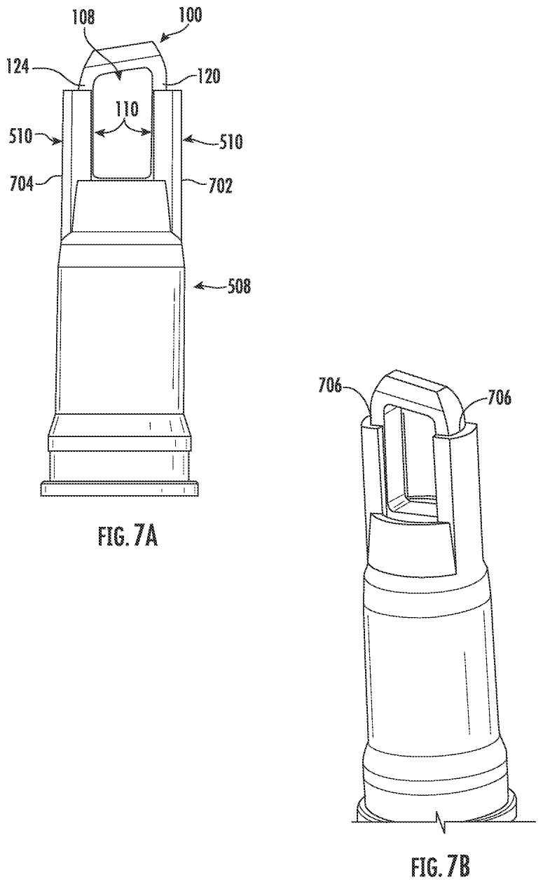

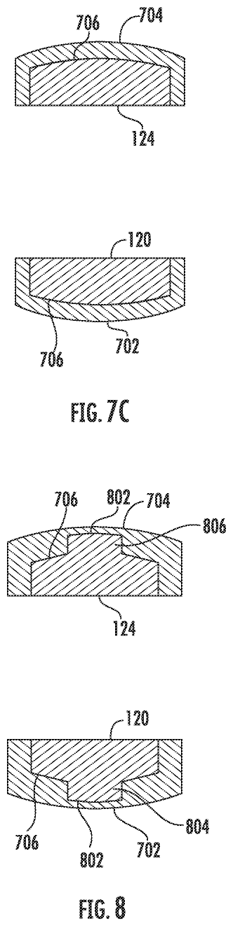

FIG. 7A is a side-view of a ferrule 508 configured to support nib 100. Nib 100 has one or more elongated beams 110 defining a void 108, and ferrule 508 has one or more elongated support ribs 510 designed to support the one or more elongated beams 110. Anterior elongated beam 120 is supported by anterior elongated support rib 702 and posterior elongated beam 124 is supported by posterior elongated support rib 704. FIG. 7B is a perspective view of the ferrule 508 of FIG. 7A. Elongated support ribs 702, 704 each include a first groove 706 corresponding to the elongated beams 120, 124. FIG. 7C is a cross-sectional view of the elongated support ribs 702, 704 having first grooves 706 corresponding to elongated beams 120, 124

In some instances, the ferrule has a round base where it meets the elongated body. In other instances, the ferrule has a rectilinear base. Any suitable shaped ferrule base may be used. The elongated support ribs of the ferrule may have a curved outer boundary corresponding to similarly curved elongated beams of the nib. The elongated support ribs may extend the entire length of the elongated beams, or the elongated support ribs may extend only a portion of the length of the elongated beams so as to permit a larger portion of the elongated beams to be exposed. In some instances, the elongated support ribs terminate with a flat surface perpendicular to a longitudinal axis of the ferrule. In other instances, the elongated support ribs have a tapered end.

FIG. 8 is a cross-sectional view of the elongated support ribs 702, 704 having first grooves 706 corresponding to elongated beams 120, 124. Anterior elongated support rib 702 further includes a second groove 802 corresponding to a first protrusion 804 of the anterior elongated beam 120, and posterior elongated support rib 704 further includes a second groove 802 corresponding to a second protrusion 806 of the posterior elongated beam 124. In some instances, there is a single second groove and a single protrusion on each elongated beam. In other instances, there may be multiple grooves and multiple protrusions on each elongated beam. The protrusion may have a curved shape, or it may be rectilinear. Any suitable shape and size of protrusion and second groove may be used to support and secure the nib in the ferrule.

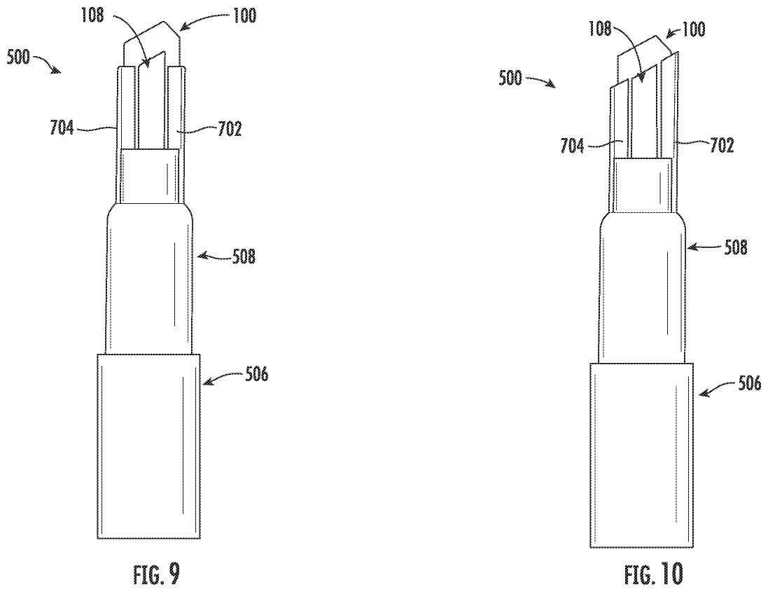

FIG. 9 is a side view of a writing instrument 500 having ferrule 508 disposed at an end 506 of the elongated body. Nib 100 is disposed in the ferrule 508. Anterior elongated support rib 702 and posterior elongated support rib 704 have the same length. FIG. 10 is a side view of a writing instrument 500 with anterior elongated support rib 702 having a length greater than posterior elongated support rib 704. In some instances, the nib has a writing beam that is angled and the elongated support ribs have lengths substantially corresponding to the angled writing beam. The elongated support ribs may terminate in an angle surface, with the angle corresponding to the angle of the writing beam. In other instances, the elongated support ribs have equal lengths, regardless of the angle of the writing beam.

Writing instruments and associated nib assemblies have been provided. These writing instruments include nib assemblies with fibrous nib bodies defining voids through which writing surfaces can be viewed when used. In some embodiments, the nib is self-supporting, while in other embodiments, the nib is supported by a ferrule with one or more elongated support ribs corresponding to one or more elongated beams of the nib.

Example

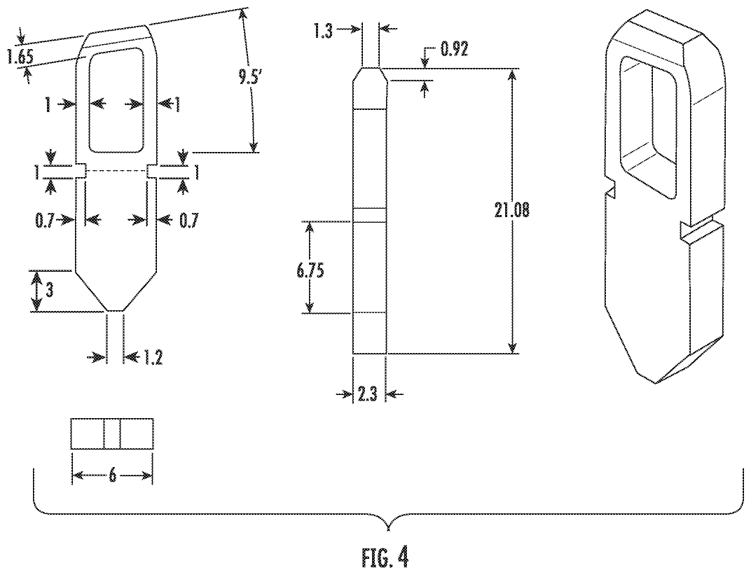

FIG. 4 provides exemplary dimensions for a fibrous nib as described herein.

While the disclosure has been described with reference to a number of embodiments, it will be understood by those skilled in the art that the disclosure is not limited to such disclosed embodiments. Rather, the disclosure can be modified to incorporate any number of variations, alterations, substitutions, or equivalent arrangements not described herein, but which are commensurate with the spirit and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

1. A nib for a writing instrument, the nib comprising:
a self-supporting fibrous nib body comprising an upper writing portion and a lower portion in communication with the upper writing portion, the upper writing portion of the fibrous nib body being configured to deliver ink to a writing surface and defining a void in a two-dimensional plane bounded by at least one elongated beam,
wherein the void allows observation of the writing surface therethrough,
wherein a first notch is disposed on a posterior side of the fibrous nib body and a second notch is disposed on an anterior side of the fibrous nib body,
wherein the first notch and the second notch define a boundary between the lower portion of the fibrous nib body and the upper writing portion of the fibrous nib body.

2. The nib of claim 1, wherein the nib is monolithic.

3. The nib of claim 1, wherein the fibrous nib body comprises a plurality of fibers and a resin.

4. The nib of claim 1, wherein the first notch and the second notch extend into the fibrous nib body from 0.1 mm to 1.5 mm.

5. The nib of claim 1, wherein the lower portion of the fibrous nib body and the upper writing portion of the fibrous nib body are substantially equal in area.

6. The nib of claim 1, wherein the lower portion of the fibrous nib body has an area greater than the upper writing portion of the fibrous nib body.

7. The nib pf claim 1, wherein the lower portion of the fibrous nib body has an area lesser than the upper writing portion of the fibrous nib body.

8. The nib of claim 1, wherein the void is a punched area in the upper writing portion of the fibrous nib body.

9. The nib of claim 1, wherein the fibrous nib body has a thickness of 1 mm to 4 mm.

10. The nib of claim 1, wherein the at least one elongated beam of the nib comprises an anterior elongated beam and a posterior elongated beam.

11. The nib of claim 10, wherein the void is bordered on an anterior side by the anterior elongated beam having a thickness of 0.5 mm to 1.5 mm, on a posterior side by the posterior elongated beam having a thickness of 0.5 mm to 1.5 mm, and on an inferior side by an inferior piece of the upper writing portion of the fibrous nib body.

12. The nib of claim 1, wherein the upper writing portion of the fibrous nib body has a writing beam located superior to the void.

13. The nib of claim 12, wherein the writing beam has one or more beveled edges.

14. The nib according to claim 12, wherein the writing beam is perpendicular to the at least one elongated beam.

15. The nib of claim 12, wherein the writing beam is positioned at an angle to the perpendicular defined by the at least one elongated beam.

16. The nib of claim 15, wherein the angle is greater than 0° and up to 45°.

17. The nib of claim 15, wherein the angle is 9.5°.

18. The nib of claim 12, wherein the writing beam extends along a longitudinal axis from 1 mm to 2.5 mm.

19. The nib of claim 1, wherein the fibrous nib body has a length of 15 mm to 30 mm and a width of 5 mm to 10 mm.

20. A writing instrument, comprising:
an elongated body comprising an ink reservoir; and
a nib of claim 1 disposed at an end of the elongated body,
wherein the lower portion of the fibrous nib body is disposed inside the end of the elongated body and is configured to deliver ink from the ink reservoir to the upper writing portion of the fibrous nib body, the upper writing portion of the fibrous nib body protruding outside of the end of the elongated body.

21. A writing instrument, comprising:
an elongated body comprising an ink reservoir;
a ferrule disposed at an end of the elongated body; and
a nib comprising a self-supporting fibrous nib body comprising an upper writing portion and a lower portion in communication with the upper writing portion, the upper writing portion of the fibrous nib body being configured to deliver ink to a writing surface and defining a void in a two-dimensional plane bounded by at least one elongated beam, wherein the void allows observation of the writing surface therethrough,
wherein a first notch is disposed on a posterior side of the fibrous nib body and a second notch is disposed on an anterior side of the fibrous nib body,
wherein the first notch and the second notch define a boundary between the lower portion of the fibrous nib body and the upper writing portion of the fibrous nib body,
wherein the lower portion of the fibrous nib body is disposed inside the end of the elongated body and is configured to deliver ink from the ink reservoir to the upper writing portion of the fibrous nib body,
wherein the upper writing portion of the fibrous nib body protrudes outside the end of the elongated body, and
wherein the ferrule comprises at least one elongated support rib for supporting the at least one elongated beam of the nib.

22. The writing instrument of claim 21, wherein the at least one elongated beam comprises a posterior elongated beam and an anterior elongated beam.

23. The writing instrument of claim 22, wherein the at least one elongated support rib of the ferrule comprises an anterior elongated support rib and a posterior elongated support rib.

24. The writing instrument of claim 23, wherein the anterior elongated support rib of the ferrule supports the anterior elongated beam of the fibrous nib body, and the posterior elongated support rib of the ferrule supports the posterior elongated beam of the fibrous nib body.

25. The writing instrument of claim 24, wherein the anterior elongated support rib of the ferrule and posterior elongated support rib of the ferrule each comprise a first groove corresponding to the anterior elongated beam of the fibrous nib body and the posterior elongated beam of the fibrous nib body,
wherein the first grooves support the fibrous nib body and prevent the fibrous nib body from deforming in use.

26. The writing instrument of claim 25, wherein the anterior elongated support rib of the ferrule and posterior elongated support rib of the ferrule each further comprise a second groove within the first groove corresponding to a first protrusion on the anterior elongated beam of the fibrous nib body and a second protrusion on the posterior elongated beam of the fibrous nib body,
wherein the second groove secures the fibrous nib body and prevents the fibrous nib body from detaching from the ferrule.

27. The writing instrument of claim 23, wherein the anterior elongated support rib of the ferrule and posterior elongated support rib of the ferrule are substantially equal in length.

28. The writing of claim 23, wherein the anterior elongated support rib of the ferrule has a length greater than a length of the posterior elongated support rib of the ferrule.

29. The writing instrument of claim 21, wherein the fibrous nib body is monolithic.

30. The writing instrument of claim 21, wherein the fibrous nib body comprises a plurality of fibers and a resin.

31. The writing instrument of claim 21, wherein a first notch is disposed on an anterior side of the fibrous nib body and a second notch is disposed on a posterior side of the fibrous nib body, and
wherein the first notch and the second notch define a boundary between the lower portion of the fibrous nib body and the upper writing portion of the fibrous nib body.

32. The writing instrument of claim 21, wherein the void is a punched area in the upper writing portion of the fibrous nib body.

33. The writing instrument of claim 21, wherein the fibrous nib body has a thickness of 1 mm to 4 mm.

34. The writing instrument of claim 21, wherein the void is bordered on an anterior side by the anterior elongated beam of the fibrous nib body having a thickness of 0.5 mm to 1.5 mm, on a posterior side by the posterior elongated beam of the fibrous nib body having a thickness of 0.5 mm to 1.5 mm, on a superior side by the upper writing portion of the fibrous nib body, and on an inferior side by an inferior piece of the upper writing portion of the fibrous nib body.

35. The writing instrument of claim 21, wherein the writing instrument is a highlighter, permanent marker, dry-erase marker, or pen.
